(19) United States
(12) Patent Application Publication
(10) Pub. No.: US 2016/0377958 A1
(43) Pub. Date: Dec. 29, 2016

(54) TERAHERTZ WAVE GENERATING APPARATUS AND INFORMATION OBTAINING APPARATUS

(71) Applicant: CANON KABUSSHIKI KAISHA, Tokyo (JP)

(72) Inventor: Toshihiko Ouchi, Machida-shi (JP)

(21) Appl. No.: 14/903,270

(22) PCT Filed: Jul. 10, 2014
(86) PCT No.: PCT/JP2014/068971

§ 371 Date: Jan. 6, 2016

(30) Foreign Application Priority Data
Jul. 18, 2013 (JP) 2013-149674
Jun. 12, 2014 (JP) 2014-121912

(51) Int. Cl. G02F 1/383; G01N 21/3581; G02F 1/37

(52) U.S. Cl. CPC G02F 1/383; G02F 1/37; G01N 21/3581; G02F 2203/13; G02F 2001/374

(57) ABSTRACT

The present invention relates to a terahertz wave generating apparatus including a terahertz wave generating element including a nonlinear optical crystal that generates a terahertz wave in response to light incident on the nonlinear optical crystal, a coupling member to extract the terahertz wave generated from the nonlinear optical crystal, a photodetector to detect light emitted from the nonlinear optical crystal, and an adjusting unit to adjust the light incident on the nonlinear optical crystal based on a result of detection by the photodetector.

### TECHNICAL FIELD

The present invention relates to a terahertz wave generating apparatus that generates a terahertz wave and an information obtaining apparatus.

### BACKGROUND ART

A terahertz wave is an electromagnetic wave including components in a predetermined frequency band in the range from 0.03 THz to 30 THz. Examples of developed inspection techniques using terahertz waves include a spectroscopic technique for inspecting the physical properties of a sample using time-domain spectroscopy (TDS) and a biomolecular analysis technique.

Methods of generating a terahertz wave include a method using a nonlinear optical crystal. This method using a nonlinear optical crystal utilizes a second-order nonlinear optical phenomenon. Examples of this method include difference frequency generation caused by two laser beams having different frequencies incident on a nonlinear optical crystal, monochromatic terahertz wave generation based on an optical parametric process, and pulsed terahertz wave generation based on optical rectification with ultra-short pulsed laser beam irradiation.

As regards terahertz wave generation using a nonlinear optical crystal, an electro-optic Cherenkov radiation phenomenon (hereinafter, also referred to as “Cherenkov radiation”), as disclosed in PTL 1, has recently received attention. The electro-optic Cherenkov radiation phenomenon enables generation of a terahertz wave having a high intensity and a relatively wide frequency band. Thus, an information obtaining apparatus using a terahertz wave can achieve higher accuracy measurement.

FIG. 7 illustrates the electro-optic Cherenkov radiation phenomenon in which a generated terahertz wave 702 is conically radiated like a shock wave when the propagation group velocity of a laser beam 701 propagating through a nonlinear optical crystal is higher than the propagation phase velocity of the terahertz wave 702. In this case, the angle θ_{c} of radiation is given by Expression (1).

$$\begin{matrix}[ Math . 1 ] & \\ cos {θ}_{c} = \frac{{v}_{THz}}{{v}_{g}} = \frac{{n}_{g}}{{n}_{THz}} & ( 1 )\end{matrix}$$

where v_{g} denotes the propagation group velocity of the laser beam 701, n_{g} denotes a group refractive index for the laser beam 701, v_{THz} denotes the propagation phase velocity of the terahertz wave 702, and n_{THz} denotes a group refractive index for the terahertz wave 702.

In measurement using a terahertz wave, fluctuations in power and pulse shape of the terahertz wave affect the accuracy of measurement. Accordingly, it is necessary to obtain a stable terahertz wave. In terahertz wave generation using a nonlinear optical crystal, however, the power and pulse shape of the terahertz wave generated from the nonlinear optical crystal are unstable because, for example, the power and pulse width of a laser beam incident on the nonlinear optical crystal are unstable.

PTL 2 discloses a method of stabilizing a harmonic, such as a second harmonic or a fourth harmonic, generated by a single wavelength laser beam incident on a nonlinear optical crystal. A laser beam component which has propagated through the nonlinear optical crystal but has not been converted into a harmonic is detected and feedback control is performed based on a result of detection to adjust the wavelength of the laser beam, thus stabilizing the power of the harmonic to be generated.

### CITATION LIST

### Patent Literature

PTL 1 Japanese Patent Laid-Open No. 2012-14155

PTL 2 Japanese Patent Laid-Open No. 6-123907

To generate a terahertz wave using a nonlinear optical crystal, as described above, the nonlinear optical crystal is irradiated with two laser beams having different frequencies or an ultra-short pulsed laser beam having a wide frequency band. Accordingly, if the method of adjusting the wavelength of a single wavelength laser beam to stabilize an electromagnetic wave generated, as disclosed in PTL 2, is used for generation, the generated terahertz wave may fail to be stabilized.

### SUMMARY OF INVENTION

### Solution to Problem

An aspect of the present invention provides a terahertz wave generating apparatus including a terahertz wave generating element including a nonlinear optical crystal that generates a terahertz wave in response to light incident on the nonlinear optical crystal, a coupling member to extract the terahertz wave generated from the nonlinear optical crystal, a photodetector to detect light emitted from the nonlinear optical crystal, and an adjusting unit to adjust the light incident on the nonlinear optical crystal based on a result of detection by the photodetector.

Further features of the present invention will become apparent from the following description of exemplary embodiments with reference to the attached drawings.

### BRIEF DESCRIPTION OF DRAWINGS

FIG. 1A is a diagram illustrating the configuration of an information obtaining apparatus according to a first embodiment.

FIG. 1B is a diagram illustrating an exemplary irradiation of a sample with a terahertz wave in the first embodiment.

FIG. 2A is a longitudinal sectional view of a terahertz wave generating element in the first embodiment.

FIG. 2B is a perspective view illustrating an exemplary configuration of the terahertz wave generating element and that of a coupling member in the first embodiment.

FIG. 3 is a diagram explaining the relationship between the power of a laser beam passed through a waveguide and that of the terahertz wave.

FIG. 4A is a diagram illustrating the configuration of an information obtaining apparatus according to a second embodiment.

FIG. 4B is a diagram illustrating the configuration of a terahertz wave generating apparatus in the second embodiment.

FIG. 4C is a diagram explaining an exemplary method of adjusting a pulse width in the second embodiment.

FIG. 5 is a diagram explaining the configuration of an information obtaining apparatus according to a third embodiment.

FIG. 6 is a diagram illustrating an exemplary configuration of a terahertz wave generating element and that of a coupling member in a fourth embodiment.

FIG. 7 is a diagram explaining electro-optic Cherenkov radiation.

### DESCRIPTION OF EMBODIMENTS

### First Embodiment

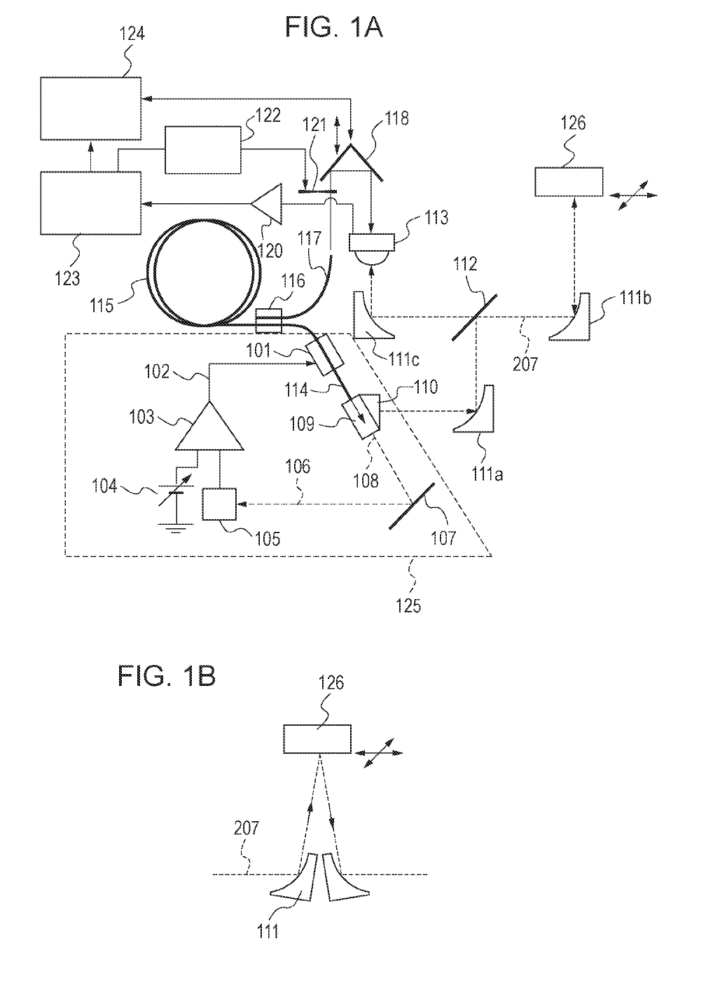

The configuration of an information obtaining apparatus according to a first embodiment will be described with reference to FIG. 1A. The information obtaining apparatus according to this embodiment obtains information about a sample using TDS.

The information obtaining apparatus includes a light source 115, a splitter 116, a terahertz wave generating apparatus 125, an optical delay unit 118, a detector 113, parabolic mirrors 111, a beam splitter 112, an amplifier 120, a modulation unit 122, a signal acquisition unit 123, and a processing unit 124.

The light source 115 is a laser light source to produce light and includes an optical fiber. In the first embodiment, the light source 115 emits an ultra-short pulsed laser beam (hereinafter, also referred to as a “laser beam”). Specifically, the light source 115 emits a femtosecond pulsed laser beam having a central wavelength of 1.55 μm, a pulse width of 20 fs, and a repetition frequency of 50 MHz. The term “ultra-short pulsed laser beam” used herein means a laser beam having a pulse width of several hundred femtoseconds or less. In particular, ultra-short pulsed laser beams having pulse widths ranging from 1 fs to 100 fs are referred to as “femtosecond pulsed laser beams”.

The splitter 116 splits the laser beam emitted from the light source 115 into two laser beams. One of the two beams passes through a fiber 114 and enters a terahertz wave generating element 109 included in the terahertz wave generating apparatus 125. The other laser beam passes through a fiber 117 and reaches the detector 113.

Each of the fibers 114 and 117 may include a highly nonlinear fiber for high-order soliton compression or a dispersion fiber for prechirping to mitigate the effect of laser beam dispersion in a path to the terahertz wave generating element 109 or the detector 113. Each of these fibers can be a polarization maintaining fiber.

The terahertz wave generating apparatus 125 is an apparatus to generate a terahertz wave and includes the terahertz wave generating element 109 and a coupling member 110. The laser beam passed through the fiber 114 is incident on a nonlinear optical crystal (not illustrated) in the terahertz wave generating element 109, so that a terahertz wave is generated. The terahertz wave propagates through the coupling member 110 and is extracted therefrom. The configuration of the terahertz wave generating apparatus 125 will be described in detail later.

The terahertz wave, indicated at 207, propagated through the coupling member 110 passes through an irradiation unit including a parabolic mirror 111a, the beam splitter 112, and a parabolic mirror 111b so as to be guided to a sample 126. Specifically, the terahertz wave 207 is reflected by the parabolic mirror 111a and is applied to the beam splitter 112. After that, the terahertz wave 207 is reflected by the beam splitter 112 and is applied to the sample 126 through the parabolic mirror 111b. The terahertz wave 207 reflected by the sample 126 passes through the beam splitter 112 and is then focused on the detector 113 by the parabolic mirror 111c.

The laser beam passed through the fiber 117 passes through the optical delay unit 118 and then enters the detector 113. At that time, the laser beam is incident on a second end of the detector 113 opposite from a first end thereof where the above-described terahertz wave 207 enters. The laser beam incident on the detector 113 will be referred to as “probe light” hereinafter.

The optical delay unit 118 is a component to adjust the difference between the length of an optical path of the laser beam from the splitter 116 to the terahertz wave generating element 109 and the length of an optical path of the probe light from the splitter 116 to the detector 113, thereby adjusting the time when the terahertz wave 207 is detected. In the first embodiment, an optical turning mechanism for turning the probe light and a moving member that moves the optical turning mechanism are used to adjust the optical path length of the probe light to the detector 113. The moving member may include a rotating system.

The optical path length adjustment is not limited to the above-described method. A method of changing, for example, the refractive index for the probe light in a propagation path to change the optical path length can be used. The optical delay unit 118 adjusts the optical path length of the probe light, serving as one of the two laser beams output from the splitter 116, to the detector 113 and the optical path length of the other laser beam, converted into the terahertz wave 207 through the terahertz wave generating element 109, to the detector 113. Accordingly, another method may be used which adjusts the optical path length of the laser beam to the terahertz wave generating element 109 or the optical path length of the terahertz wave 207 instead of the optical path length of the probe light.

The detector 113 is a component to detect the terahertz wave 207. In the first embodiment, the detector 113 is a photoconductive element including low-temperature-grown GaAs and a dipole antenna disposed thereon. If the laser beam emitted from the light source 115 has a wavelength of 1.55 μm, a second harmonic generation (SHG) crystal (not illustrated) may be disposed on the propagation path of the probe light. A second harmonic generated with the SHG crystal allows production of probe light suitable for excitation of GaAs. Thus, detection with a high S/N ratio can be achieved.

As regards the SHG crystal, periodically poled lithium niobate (PPLN) having a thickness of approximately 0.1 mm can be used in order to maintain the pulse shape of the laser beam. If the pulse width is sufficiently small as in this embodiment, a fundamental wave may be used as probe light.

An optical chopper 121 is disposed between the splitter 116 and the optical delay unit 118. The probe light is modulated by the optical chopper 121 and phase lock detection is performed by the detector 113. An output signal of the detector 113 is transmitted to the signal acquisition unit 123. The optical chopper 121 is controlled by the modulation unit 122.

The signal acquisition unit 123 is a component to acquire an output signal from the detector 113. The processing unit 124 forms a time-domain waveform using the output signal acquired by the signal acquisition unit 123 and processes the time-domain waveform, thus obtaining information concerning, for example, the optical properties and the shape of the sample 126.

The terahertz wave generating apparatus 125 will now be described in detail below. The terahertz wave generating apparatus 125 in the first embodiment includes an optical attenuator 101, the terahertz wave generating element 109, the coupling member 110, a reflector 107, a photodetector 105, a reference power supply 104, and an amplifier 103.

The terahertz wave generating element 109 includes the nonlinear optical crystal that generates a terahertz wave. The terahertz wave generated from the nonlinear optical crystal of the terahertz wave generating element 109 passes through the coupling member 110 and emerges therefrom. The configuration of the terahertz wave generating element 109 will now be described below.

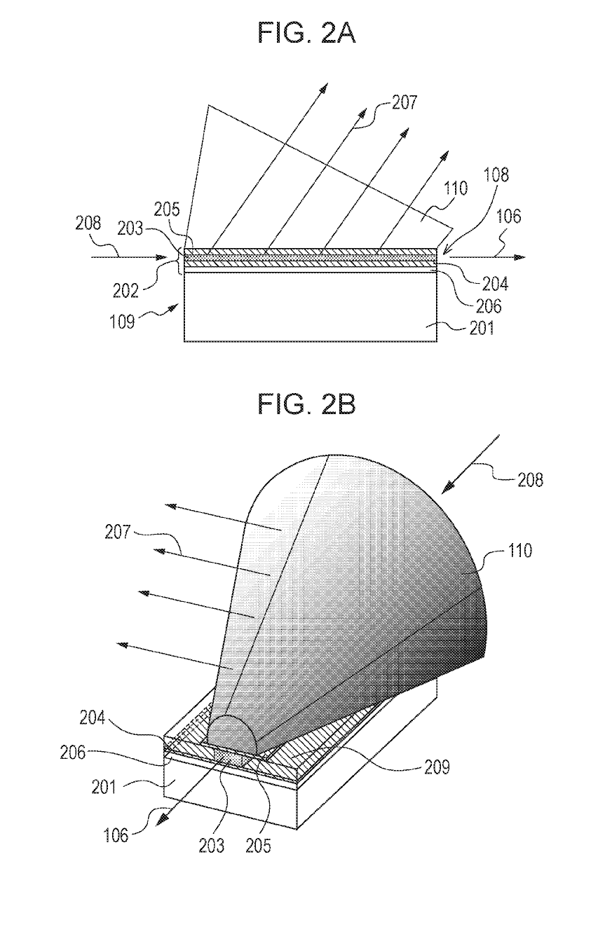

FIGS. 2A and 2B illustrate the configuration of the terahertz wave generating element 109 and that of the coupling member 110. FIG. 2A is a longitudinal sectional view including the axis of a waveguide 202 included in the terahertz wave generating element 109. FIG. 2B is a perspective view illustrating the terahertz wave generating element 109. The terahertz wave generating element 109 includes a substrate 201 and the waveguide 202.

When the laser beam enters the waveguide 202, the terahertz wave 207 is generated. The generated terahertz wave 207 is conically radiated by Cherenkov radiation, as illustrated in FIG. 2A, and passes through the coupling member 110 and emerges therefrom. The waveguide 202 includes a lower cladding layer 204 bonded to the substrate 201 with an adhesive 206, a core layer 203 through which the laser beam propagates, and an upper cladding layer 205 disposed on the core layer 203. When the laser beam propagates through the core layer 203, the terahertz wave 207 is generated.

Although the terahertz wave 207 is illustrated by straight lines for simplicity in FIGS. 2A and 2B, the terahertz wave 207 generated from the nonlinear optical crystal included in the waveguide 202 is actually refracted upon entering the coupling member 110 after propagation through the waveguide 202.

The core layer 203 is the nonlinear optical crystal. Examples of typical nonlinear optical crystals include LiNbOₓ (hereinafter, referred to as “LN”), LiTaOₓ, NbTaOₓ, KTP, DAST, ZnTe, GaSe, and GaAs. The core layer 203 may have a thickness less than or equal to half an equivalent wavelength of a highest-frequency terahertz wave component of the terahertz wave 207 in the core layer 203. In the first embodiment, the core layer 203 is made of LN. The core layer 203 may include a material other than LN.

The substrate 201 is, for example, a Y-cut LN crystal. The substrate 201 is formed such that a propagating direction of the laser beam coincides with the X axis of the LN crystal and the direction orthogonal to the propagating direction of the laser beam coincides with the Z axis of the LN crystal. Such a configuration allows a terahertz wave to be efficiently generated due to the second-order nonlinear phenomenon when a polarized ultra-short pulsed laser beam including an electric field component parallel to the Z axis is incident on the core layer 203.

Each of the lower cladding layer 204 and the upper cladding layer 205 is a layer formed of a material having a lower refractive index than the core layer 203 in a terahertz band. A laser beam 208 (hereinafter, also referred to as “incident light”) incident on the core layer 203 is confined within the core layer 203 by the lower cladding layer 204 and the upper cladding layer 205. Consequently, the incident light 208 propagates through the core layer 203 without emerging from the waveguide 202.

In the first embodiment, the substrate 201 is bonded to the lower cladding layer 204 with the adhesive 206. The upper cladding layer 205 is formed of an adhesive to bond the core layer 203 to the coupling member 110. The configuration of the waveguide 202 is not limited to the above-described configuration. For example, the substrate 201 may be bonded to the core layer 203 with an adhesive and the adhesive may function as the lower cladding layer 204.

To form the waveguide 202, areas having a lower refractive index than the core layer 203 have only to be arranged on the core layer 203 so as to sandwich the core layer 203. The waveguide 202 may be formed of any material and may be formed by any method. Specifically, the method of forming the waveguide 202 is not limited to the method of bonding members having different refractive indices with an adhesive. The waveguide 202 may be formed by a method of forming an MgO-doped LN layer in a portion of the substrate 201 made of, for example, a LN crystal by diffusion or the like. In this case, since the MgO-doped LN layer has a higher refractive index than LN, the other portion, in which the MgO-doped LN layer is not formed, of the substrate 201 functions as the lower cladding layer 204.

In the first embodiment, the waveguide 202 is ridge-shaped and is formed by etching or a method of providing the difference in refractive index between part of the core layer 203 and a surrounding area 209 by diffusing Ti in the part such that the part is allowed to have a higher refractive index. As described above, a waveguide structure is provided on each side surface of the core layer 203, thus enhancing the confinement of light. The core layer 203 may be covered with a SiOₓ layer or resin. Although the different cladding layers are arranged on the core layer 203 in the first embodiment, upper, lower, right, and left cladding layers around the core layer 203 may be integrated in one piece. Furthermore, a slab waveguide (not illustrated) may be used which includes the core layer 203 extending uniformly transversely and includes no surrounding area 209.

As regards the upper cladding layer 205, a derivative or thin film of, for example, SiOₓ or SiNₓ having a lower refractive index than LN or resin, such as PET, may be used. In addition, the upper cladding layer 205 may be thick enough to function as a cladding layer and be thin to such an extent that the influence of multiple reflection or loss is negligible when the terahertz wave is extracted from the coupling member 110.

Specifically, the thickness of the upper cladding layer 205 is set so that the intensity distribution of the laser beam emerging into each cladding layer is less than or equal to 1/e² of the intensity of the laser beam propagating through the core layer 203.

Furthermore, the thickness of the upper cladding layer 205 may be set to be less than or equal to a thickness of approximately 1/10 of the equivalent wavelength in the upper cladding layer 205 of the terahertz wave component having the highest frequency of frequencies intended to be extracted. The reason is that the influence of reflection, scattering, refraction, or the like of an electromagnetic wave in a structure can be considered as negligible so long as the structure has a thickness of approximately 1/10 of the wavelength of the electromagnetic wave. If the thickness of the upper cladding layer 205 is outside the above-described range, a terahertz wave can be generated from the terahertz wave generating element in the first embodiment.

Although the waveguide 202 which satisfies the above-described conditions includes the core layer 203 having a thickness of 3.8 μm and a width of 4 μm and the lower and upper cladding layers 204 and 205 each having a thickness of 1 μm in the first embodiment, the dimensions are not limited to these values.

The coupling member 110 is a component to extract the generated terahertz wave. The coupling member 110 is a prism made of, for example, high-resistance Si that exhibits less loss in terahertz wave. Assuming that the nonlinear optical crystal is LN and the coupling member 110 is made of high-resistance Si, the angle of Cherenkov radiation of the terahertz wave propagating through LN is approximately 65° which is obtained by Expression (1) described above. The terahertz wave radiated from LN is refracted upon entering the coupling member 110. Accordingly, the Cherenkov radiation angle θ_{clad} formed between the terahertz wave 207 passing through the coupling member 110 and the propagating direction of the laser beam 208 is approximately 49°.

Since the ridge-shaped waveguide 202 is used in the first embodiment, the generated terahertz wave in the direction orthogonal to the propagating direction of the laser beam is diverging light. On the other hand, a terahertz wave component parallel to the waveguide 202 hardly diverges. Accordingly, the coupling member 110 is shaped in a truncated cone, as illustrated in FIG. 2B, so as to have a unidirectional converging function, so that the terahertz wave can be efficiently extracted.

Although LN is used as the nonlinear optical crystal in the first embodiment, another nonlinear optical crystal may be used. Since LN allows the difference between the refractive index for a terahertz wave and that for a laser beam to be sufficiently large, the terahertz wave generated non-collinearly can be extracted.

If a nonlinear optical crystal used exhibits a small refractive index difference, the generated terahertz wave may fail to be extracted easily. In this case, the waveguide 202 may be provided such that the terahertz wave generating element 109 is in close proximity to the coupling member 110 and the coupling member 110 may be made of a material having a higher refractive index than the nonlinear optical crystal. Such a configuration satisfies the Cherenkov radiation condition (V_{THz}<V_{g}), so that the terahertz wave can be extracted.

Other components of the terahertz wave generating apparatus 125 will be described. These components are configured to feedback-control the incident light 208 in order to stabilize the terahertz wave 207.

Specifically, a laser beam (hereinafter, also referred to as “emitted light”) 106 which has propagated through the waveguide 202 and emerged from an emitting surface 108 without being converted into the terahertz wave is detected and the power of the laser beam 208 is adjusted in accordance with a result of detection. The average power of the laser beam (emitted light) 106 emitted from the emitting surface 108 ranges from approximately 10% to approximately 50% of the power of the incident light 208 depending on the structure or the like of the waveguide.

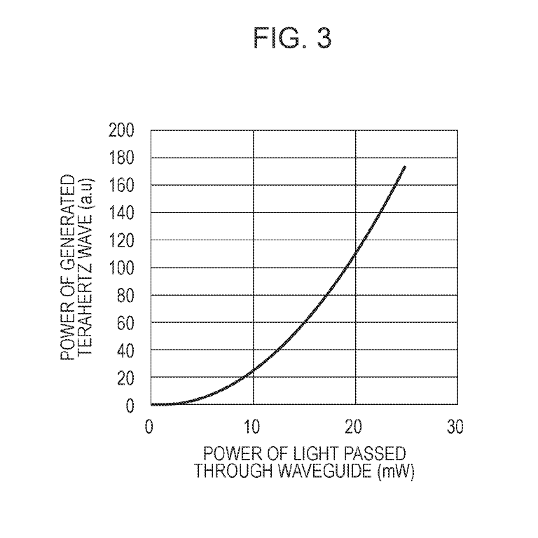

A definite relationship between the power of the emitted light 106 and the power of the generated terahertz wave 207 as illustrated in FIG. 3 has been found by examination by the inventor. Accordingly, the power of the generated terahertz wave 207 can be indirectly monitored by observing the emitted light 106. The power of the terahertz wave 207 can be stabilized by adjusting the power of the incident light 208 with reference to the intensity of the emitted light 106. Since the intensity of the emitted light 106 reflects fluctuations in coupling efficiency of the laser beam 208 to the waveguide 202, the observation of the intensity of the emitted light 106 means that the generation power (intensity) of the terahertz wave 207 can be adjusted depending on the effect of fluctuations in coupling efficiency.

The photodetector 105 detects the emitted light 106. The emitted light 106 emitted from the emitting surface 108 is reflected by the reflector 107 and is then incident on the photodetector 105. A result of detection by the photodetector 105 is output as a voltage depending on the intensity of the emitted light 106. The photodetector 105 typically has a light receiving area in the range of several hundred micrometers to approximately one millimeter. Accordingly, if the emitted light 106 is affected by fluctuations of an optical system to the photodetector 105, the result of detection by the photodetector 105 reflects little effect. Consequently, stable feedback control can be performed. If the photodetector 105 detects pulsed light, the average power of the pulsed light is output as a voltage.

The reference power supply 104 is set to a predetermined constant voltage. The amplifier 103 outputs an electrical signal 102 as a differential output indicating the difference between the voltage of the reference power supply 104 and the voltage as the result of detection by the photodetector 105 to the optical attenuator 101.

The optical attenuator 101 is an adjusting unit to adjust the power of a laser beam. The optical attenuator 101 acquires the electrical signal 102 and changes the amount of optical attenuation, by which the laser beam is attenuated, in accordance with this signal, thus adjusting the power of the laser beam incident on the terahertz wave generating element 109.

Specifically, the value of the reference power supply 104 is set to a predetermined value. When the result of detected by the photodetector 105 is lower than the predetermined value, the optical attenuator 101 increases the power of the laser beam. When the result of detection by the photodetector 105 is higher than the predetermined value, the optical attenuator 101 reduces the power of the laser beam. In this case, the diagram illustrating the relationship between the power of the emitted light 106 and the power of the terahertz wave 207 as illustrated in FIG. 3 may be previously stored as data.

Specifically, the diagram illustrating the relationship between the power of the emitted light 106 and that of the terahertz wave 207 as illustrated in FIG. 3 is previously obtained depending on a system including the terahertz wave generating apparatus 125 used and data indicating the diagram is stored in a memory unit (not illustrated) in the information obtaining apparatus. A voltage value of the reference power supply 104 may be controlled and set with reference to the relationship diagram so that intended power of the terahertz wave is obtained. The information obtaining apparatus does not necessarily have to include the memory unit. The data indicating the relationship diagram can be stored in and retrieved from a detachable memory unit or an external memory unit via a communication unit. Consequently, as described above, the power of the incident light 208 can be adjusted in the terahertz wave generating apparatus 125.

In the first embodiment, the electrical signal indicating the difference between the voltage of the reference power supply 104 and the voltage depending on the result of detection by the photodetector 105 is output and the optical attenuator 101 is controlled based on this electrical signal. The method of controlling the optical attenuator 101 is not limited to the above-described method. For example, the relationship between the result of detection by the photodetector 105 and the amount of attenuation by the optical attenuator 101 may be previously recorded as a table and the amount of attenuation may be determined with reference to the table. The optical attenuator 101 may be controlled based on the determined amount of attenuation.

The predetermined value as a reference to adjust the ultra-short pulsed laser beam may be determined by a user as appropriate. Alternatively, a value determined based on the power of the light source 115 and the conversion efficiency of the terahertz wave generating element 109 may be used. Alternatively, for example, a method of adjusting the power to a constant value with reference to the power of the preceding laser beam may be used.

Such a configuration enables stabilization of the power of the terahertz wave 207 to be generated. In addition, since feedback control is performed based on the result of detection of the laser beam 106 which has propagated through the nonlinear optical crystal (the core layer 203) and has been emitted therefrom, adjustment depending on an effect caused by, for example, positional deviation of the laser beam incident on the waveguide 202 from the waveguide 202 or the angle of incidence can be achieved.

Specifically, if the laser beam is deviated from the waveguide 202 upon entering the waveguide 202, alternatively, if the laser beam enters the waveguide 202 at an incident angle, feedback control can be performed based on a result of detection of the affected laser beam. Accordingly, the power of the terahertz wave 207 to be generated can be adjusted more accurately than that in feedback control based on the result of detection of the incident light 208.

Since the laser beam emitted from the nonlinear optical crystal is detected in the first embodiment, the laser beam used to generate the terahertz wave does not have to be split to produce a laser beam to be detected by the photodetector 105. Accordingly, feedback control to stabilize the terahertz wave 207 can be performed without reducing the laser beam emitted from the light source 115. Thus, the laser beam emitted from the light source 115 can be more efficiently used.

Furthermore, the terahertz wave 207 can be generated without reducing the laser beam from the light source 115 and the generated terahertz wave 207 can be used without being reduced in the first embodiment. Accordingly, the terahertz wave 207 can be used whose power is higher than that of the terahertz wave 207 stabilized based on a result of detection of part split from the generated terahertz wave 207.

Although the method using the optical attenuator 101 as an adjusting unit to adjust the power of a laser beam has been described in the first embodiment, the adjustment is not limited to the above-described method. For example, a light source provided with an adjusting unit may be used. In this case, an adjusting unit that causes no degradation in quality, such as a pulse width, of an ultra-short pulsed laser beam can be used.

### Second Embodiment

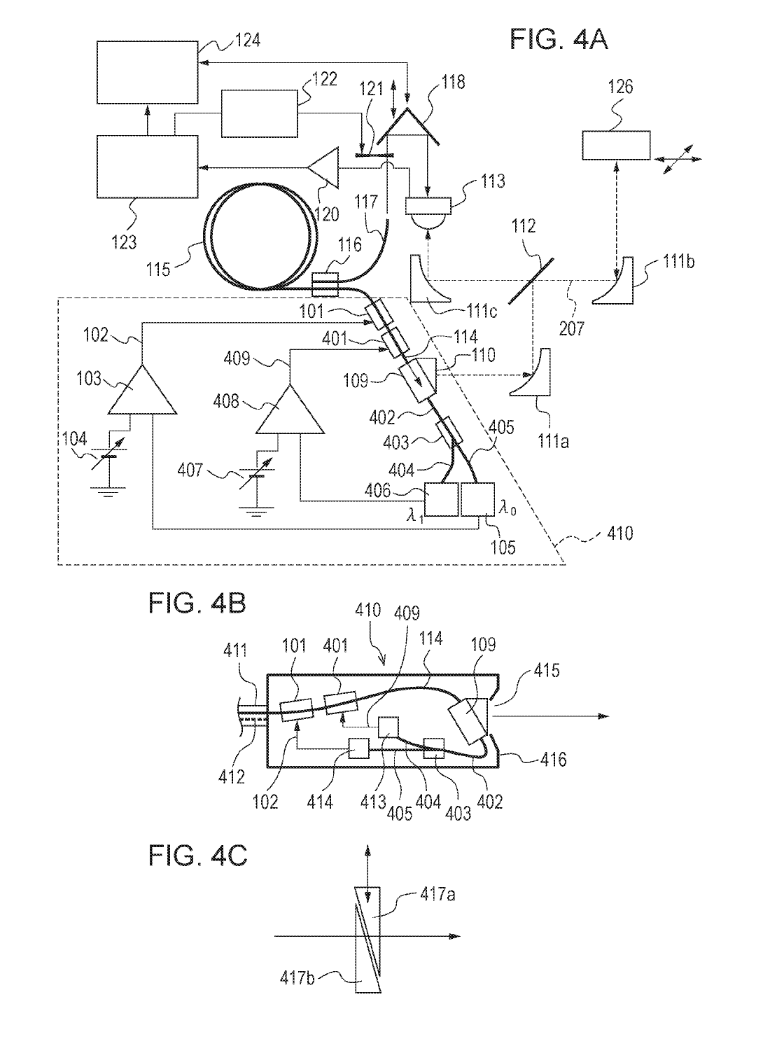

The configuration of an information obtaining apparatus according to a second embodiment will be described with reference to FIG. 4A. A description of the same components as those in the first embodiment is omitted in the second embodiment. FIG. 4A illustrates the configuration of the information obtaining apparatus according to the second embodiment.

The information obtaining apparatus according to the second embodiment includes a terahertz wave generating apparatus 410 whose configuration differs from that of the terahertz wave generating apparatus 125 in the first embodiment. Specifically, although the terahertz wave 207 is stabilized by adjusting the power of light entering the waveguide 202 in the first embodiment, the pulse shape of the terahertz wave 207 is stabilized in addition to the power of the terahertz wave by adjusting the pulse shape of pulsed light in the second embodiment. The configuration of the information obtaining apparatus except the configuration of the terahertz wave generating apparatus 410 is the same as that of the information obtaining apparatus according to the first embodiment.

According to the second embodiment, an ultra-short pulsed laser beam (hereinafter, referred to as the “laser beam”) enters the nonlinear optical crystal, thus generating the terahertz wave 207 in the same way as the first embodiment. When the terahertz wave 207 is generated using the nonlinear optical crystal, harmonics, such as the second harmonic and the third harmonic, of the laser beam are generated at the same time. For example, when a laser beam having a wavelength of 1.55 μm propagates through the terahertz wave generating element 109 including LN, pulsed light having a wavelength of 0.78 μm, serving as the second harmonic, and pulsed light having a wavelength of 0.52 μm, serving as the third harmonic, are generated substantially collinear with a propagation path.

To adjust the pulse shape of the laser beam, specifically, the pulse width of the laser beam is adjusted in the second embodiment. Assuming that the power of the laser beam is stable, as the pulse width is narrower, the peak intensity of the laser beam is higher, leading to an increase in power of harmonics. Feedback control based on such a condition enables adjustment of the pulse shape. A target to be adjusted is not limited to the pulse width of the laser beam. For example, the shape of a pulse wave may be adjusted.

A mechanism for generating a pulsed terahertz wave from a nonlinear optical crystal is attributed to coherent generation of a terahertz wave having a wavelength corresponding to beats of wide-band wavelength spectrum components included in a laser beam, the generation being due to the effect of optical rectification. Simultaneously stabilizing the power and pulse width of a laser beam results in stabilization of the power and pulse shape of the terahertz wave 207.

If the power of the laser beam is accurately stabilized in the light source 115, each of the power and the pulse width do not necessarily have to be stabilized. Only the pulse shape may be adjusted.

The terahertz wave generating apparatus 410 in the second embodiment includes the terahertz wave generating element 109 and the coupling member 110. The configuration of the terahertz wave generating element 109 and that of the coupling member 110 are the same as those in the first embodiment. Like the terahertz wave generating apparatus 125 in the first embodiment, the terahertz wave generating apparatus 410 includes an optical power adjustment mechanism including the optical attenuator 101, serving as a first adjusting unit to adjust power, the photodetector 105, the reference power supply 104, and the amplifier 103. The terahertz wave generating apparatus 410 further includes a pulse width adjustment mechanism including a second photodetector 406 different from the photodetector 105, which serves as a first photodetector, a reference power supply 407, an amplifier 408, and a pulse width adjusting unit 401, which serves as a second adjusting unit to adjust a pulse width as a pulse shape.

The terahertz wave generating apparatus 410 includes a wavelength separator 403. A laser beam (emitted light) passed through the terahertz wave generating element 109 passes through an optical fiber 402 and is then separated through the wavelength separator 403 into a fundamental wave λ₀ and a harmonic component λ₁ including the second harmonic and the third harmonic. The fundamental wave λ₀ passes through a fiber 405 and is then detected by the first photodetector 105. The optical attenuator 101 controls the power of the laser beam incident on the nonlinear optical crystal in accordance with a result of detection by the photodetector 105 in the same way as the first embodiment.

The harmonic component λ₁ passes through a fiber 404 and then enters the second photodetector 406. The harmonic component λ₁ is converted into an electrical signal depending on the intensity of the harmonic component λ₁ by the second photodetector 406. An electrical signal 409 indicating the difference between the electrical signal and a voltage of the reference power supply 407 is output from the amplifier 408 to the pulse width adjusting unit 401.

The pulse width adjusting unit 401 is a component to adjust the pulse width of the laser beam in response to the electrical signal 409. Examples of techniques for adjusting the pulse width in the pulse width adjusting unit 401 include a method using two wedge-shaped dispersive media 417a and 417b, as illustrated in FIG. 4C. The laser beam is allowed to propagate through the dispersive media 417a and 417b. The amount of dispersion is adjusted by moving the dispersive medium 417a in a direction indicated by arrows.

In the second embodiment, the harmonic component X including the second and third harmonics emitted from the waveguide 202 is detected. If a component to increase the power of the harmonic component is not provided, the second harmonic whose power is typically approximately 1/10 of the power of the fundamental wave (when the waveguide has a length of 1 mm) is obtained. Since the third harmonic has smaller power, light corresponding to the second harmonic can be considered as detected.

If the power of the harmonic component is intended to increase in order to enhance the accuracy of pulse width adjustment, the coupling efficiency may be increased by changing the configuration of the waveguide 202 to a configuration for harmonics, alternatively, the efficiency of harmonic generation may be increased by allowing the waveguide 202 to have a PPLN structure. Alternatively, a crystal for harmonic generation having a PPLN structure may be connected in series to the waveguide 202 in order to generate a signal to control the pulse shape.

The terahertz wave generating apparatus 410 in the second embodiment is constructed as a module as illustrated in FIG. 4B. Specifically, the components of the terahertz wave generating apparatus 410 are accommodated in a housing 416. The housing 416 has an opening 415 through which the generated terahertz wave 207 is emitted outwardly. The housing 416 is connected to the light source 115 via a cable 411. The cable 411 accommodates the fiber 114 for guiding the ultra-short pulsed laser beam and an electric wire 412 including a power supply line.

A fundamental wave detecting unit 414 in FIG. 4B is an integrated combination of the photodetector 105, the reference power supply 104, and the amplifier 103 in FIG. 4A. A harmonic detecting unit 413 is an integrated combination of the photodetector 406, the reference power supply 407, and the amplifier 408 in FIG. 4A. Since the terahertz wave generating apparatus is constructed as a small module, this small generating apparatus can be applied to a small information obtaining apparatus, such as a laparoscope or an endoscope.

The form of the terahertz wave generating apparatus can be designed for purpose. The terahertz wave generating apparatus does not necessarily have to be constructed as a module illustrated in the second embodiment. Although the components of the terahertz wave generating apparatus are connected by optical fibers for modularization, the generating apparatus may be constructed as a spatial optical system without using optical fibers.

The terahertz wave generating apparatus 410 in the second embodiment can stabilize the terahertz wave 207 to be generated. Since the power and pulse shape of the ultra-short pulsed laser beam can be controlled, not only the power of the terahertz wave 207 but also the pulse shape thereof can be stabilized.

### Third Embodiment

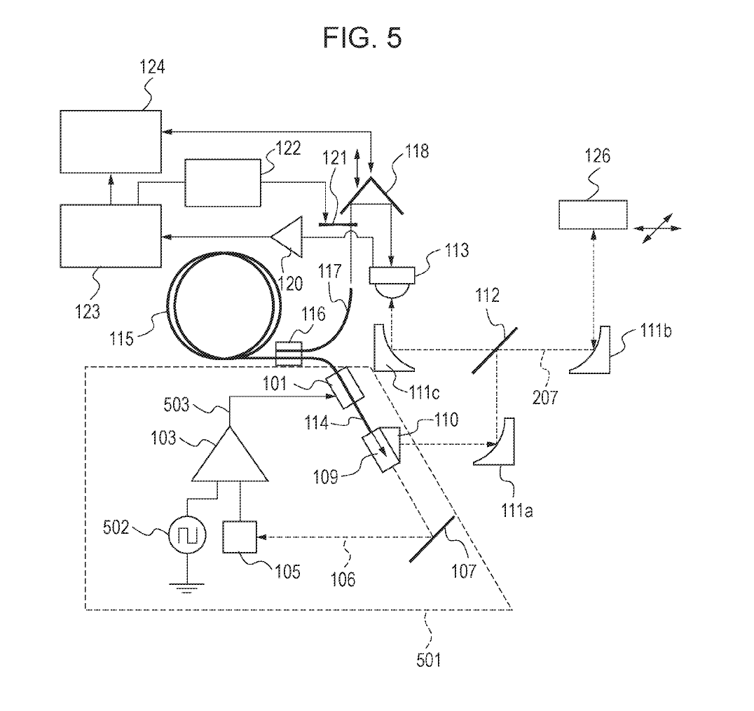

A third embodiment will be described with reference to FIG. 5. FIG. 5 is a diagram explaining the configuration of an information obtaining apparatus according to this embodiment. The configuration of a terahertz wave generating apparatus 501 in the third embodiment differs from that of the terahertz wave generating apparatus 125 in the first embodiment. The construction of the information obtaining apparatus except the configuration of the terahertz wave generator 501 is the same as that according to the first embodiment. Specifically, while the first embodiment uses the reference power supply 104 that provides a constant voltage in the terahertz wave generating apparatus 125, the third embodiment uses a modulation power source 502 that provides a variable voltage as a modulating signal. The power of a laser beam is adjusted depending on the difference between the voltage of the modulation power source 502 and a voltage detected by the photodetector 105.

A laser beam emitted from the nonlinear optical crystal is detected by the photodetector 105 and a result of detection is compared with a predetermined value in the same way as in the first embodiment. When the result of detection is greater than the predetermined value, the optical attenuator 101 reduces the power of the laser beam incident on the waveguide 202 (or the nonlinear optical crystal). When the result of detection is less than the predetermined value, the optical attenuator 101 increases the power of the laser beam incident on the waveguide 202.

In the third embodiment, the modulation power source 502 outputs a modulated voltage as a modulating signal. The voltage, serving as a reference for laser beam adjustment, accordingly varies. The laser beam whose power depends on a variation in voltage enters the terahertz wave generating element 109. This results in a variation in power of the terahertz wave 207 to be generated. Since the signal from the modulation power source 502 is modulated into a signal having any shape, for example, a sine wave signal or a square wave signal, the terahertz wave 207 whose power depends on the modulating signal can be obtained.

This terahertz wave 207 can be used for signal transmission in communication, for example. If the terahertz wave generating apparatus in the third embodiment is used as a terahertz wave generation source of the information obtaining apparatus, signal processing with reduced noise can be performed. The accuracy of measurement can be increased.

According to the third embodiment, the terahertz wave 207 with intended power can be stably obtained. This embodiment can be applied not only to laser beam power adjustment but also to adjustment of the pulse shape of a pulsed laser beam.

### Fourth Embodiment

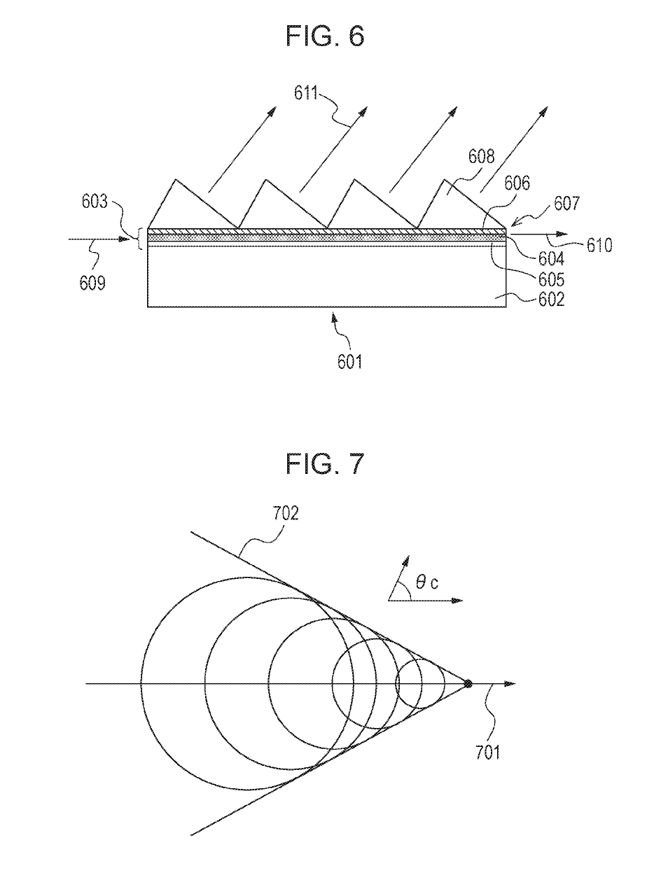

A fourth embodiment will be described with reference to FIG. 6. FIG. 6 illustrates an exemplary configuration of a terahertz wave generating element in this embodiment. In the above-described first to third embodiments, the ultra-short pulsed laser beam is used as light and the pulsed terahertz wave 207 is generated by optical rectification. On the other hand, the terahertz wave generating apparatus in the fourth embodiment allows two laser beams 609 having different frequencies to enter a nonlinear optical crystal included in a terahertz wave generating element 601, thus generating a terahertz wave 611. Let ν1 and ν2 denote the frequencies of the laser beams 609.

The terahertz wave generating element 601 in the fourth embodiment includes a LN substrate 602 and a waveguide 603. The waveguide 603 includes a core layer 604, a lower cladding layer 605, and an upper cladding layer 606.

The core layer 604 is a MgO-doped LN layer. The lower cladding layer 605 functions as an adhesive layer to bond the core layer 604 to the LN substrate 602. The upper cladding layer 606 is a low refractive index buffer layer.

To increase the power of the terahertz wave 611 in the fourth embodiment, the waveguide 603 has a length of 40 mm and a plurality of coupling members 608 are arranged on the waveguide 603.

When the laser beams 609 propagate through the waveguide 603, the terahertz wave 611, which is monochromatic, corresponding to the difference between the two different frequencies ν1 and ν2 is generated. For example, assuming that the difference between the frequencies ν1 and ν2 of the incident laser beams 609 ranges from 0.5 THz to 7 THz, the frequency of the radiated terahertz wave 611 can be varied in this range. As regards a laser beam source, for example, a KTP-OPO light source pumped by a Nd:YAG laser, or two variable wavelength laser diodes can be used. The generated terahertz wave 611 passes through the coupling members 608 and emerges therefrom.

The single-frequency terahertz wave 611 generated in this manner is applied to a sample and a change in power of the terahertz wave 611 passed through or reflected by the sample is observed, thus achieving imaging with the terahertz wave 611. Examples of the detector 113 for the terahertz wave 611 include a bolometer, a pyro-sensor, and a Schottky sensor.

In the terahertz wave generating apparatus in the fourth embodiment, laser beams (emitted light) 610 which have not been converted into the terahertz wave 611 are emitted from an emitting end 607. Accordingly, the emitted light 610 is detected and the power of the laser beams (incident light) 609 incident on the terahertz wave generating element 601 is adjusted based on a result of detection, so that the power of the terahertz wave 611 to be generated can be stabilized in a manner similar to the third embodiment. Since feedback control is performed based on the result of detection of light propagated through the nonlinear optical crystal, stabilization depending on an effect caused by, for example, positional deviation of light incident on the nonlinear optical crystal from the nonlinear optical crystal or the angle of incidence of the light can be achieved.

The stabilized power of the terahertz wave 611 leads to an even and clear image in imaging with the terahertz wave 611. The terahertz wave generating apparatus in the fourth embodiment can be applied to an information obtaining apparatus that performs inspection at a specific frequency or inspection with imaging, for example, inspection to check the amount of a specific substance contained in, for example, a medicine using a terahertz wave having the same frequency as that of an absorption spectrum of the substance.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

For example, the information obtaining apparatus according to each of the foregoing embodiments is constructed such that the terahertz wave applied to the sample 126 is collinear with the terahertz wave reflected by the sample 126. As illustrated in FIG. 1B, the information obtaining apparatus may further include another parabolic mirror 111 such that the terahertz wave 207 applied to the sample 126 is noncollinear with the terahertz wave 207 reflected by the sample 126. Such a configuration can increase the power of the terahertz wave 207 to be detected, though the angle of incidence on the sample 126 is not 90°.

Furthermore, although the information obtaining apparatus according to each of the foregoing embodiments detects the terahertz wave 207 reflected by the sample 126, the information obtaining apparatus is not limited to the reflection type. The information obtaining apparatus may be of a transmission type which detects the terahertz wave 207 passed through the sample.

Furthermore, the foregoing embodiments have been described with respect to the configuration in which the laser beam emitted from the light source is split into two beams by the splitter 116 and one of the two beams passes through the optical fiber 117 and enters the detector 113. The invention is not limited to this example. Part of the light emitted from the terahertz wave generating element may be used as probe light. In this case, the splitter 116 and the optical fiber 117 may be omitted. In addition, the optical delay unit 118 may be disposed on a propagation path of the laser beam between the terahertz wave generating element 109 and the detector 113.

Although the terahertz wave generating element in each of the foregoing embodiments includes the waveguide, a terahertz wave generating element including no waveguide may be used to generate a terahertz wave. In this case, light (emitted light) emitted after propagation through the nonlinear optical crystal without being converted into the terahertz wave is detected and light (incident light) entering the nonlinear optical crystal is adjusted based on a result of detection. Feedback control based on the result of detection of the emitted light enables adjustment depending on a change in power of light caused by, for example, the effect of the angle of incidence of the light entering the nonlinear optical crystal. The terahertz wave can be stabilized with higher accuracy than stabilization based on a result of detection of part of incident light.

In the first embodiment, the relationship diagram of FIG. 3 is referred to for adjustment of the power of incident light based on the result of detection of the emitted light 106. For example, a table illustrating the relationship between the power of the emitted light 106 and the power of the terahertz wave 207 may be referred to instead of the relationship diagram of FIG. 3. To detect a harmonic component of the emitted light 106 as described in the second embodiment, for example, a diagram and a table each illustrating the relationship between the power of the harmonic component and the power of the generated terahertz wave may be used. In a configuration to adjust the pulse shape of the terahertz wave, for example, a diagram and a table each illustrating the relationship between the power of the emitted light 106 and the pulse shape of the terahertz wave 207 may be referred to. Furthermore, the above-described diagrams and tables may be used in combination.

Information about these diagrams and tables may be stored in the memory unit of the information obtaining apparatus. Alternatively, the terahertz wave generating apparatus 125 may include a memory unit and the information may be stored in the memory unit. Alternatively, the information may be obtained in any way, for example, may be read from a detachable memory device or a memory device included in the processing unit 124 illustrated in FIG. 1A, or may be downloaded from a cloud computing system. The obtained information may be controlled.

This application claims the benefit of Japanese Patent Application No. 2013-149674, filed Jul. 18, 2013, and Japanese Patent Application No. 2014-121912, filed Jun. 12, 2014, which are hereby incorporated by reference herein in their entirety.

1. A terahertz wave generating apparatus comprising:
a terahertz wave generating element including a nonlinear optical crystal configured to generates a terahertz wave in response to light incident on the nonlinear optical crystal;
a coupling member configured to extract the terahertz wave generated from the nonlinear optical crystal;
a photodetector configured to detect light emitted from the nonlinear optical crystal; and
an adjusting unit configured to adjust the light incident on the nonlinear optical crystal based on a result of detection by the photodetector.

2. The apparatus according to claim 1, wherein the adjusting unit adjusts power of the light incident on the nonlinear optical crystal.

3. The apparatus according to claim 1,
wherein the light incident on the nonlinear optical crystal is pulsed light, and
wherein the adjusting unit adjusts a shape of a pulse of the light incident on the nonlinear optical crystal.

4. The apparatus according to claim 2, wherein the adjusting unit reduces the power when the result of detection by the photodetector is greater than a predetermined value, and increases the power when the result of detection by the photodetector is less than the predetermined value.

5. The apparatus according to claim 3, wherein the adjusting unit reduces a width of the pulse when the result of detection by the photodetector is greater than a predetermined value, and increases the width of the pulse when the result of detection by the photodetector is less than the predetermined value.

6. The apparatus according to claim 4, wherein the predetermined value varies depending on a modulating signal.

7. The apparatus according to claim 1, further comprising:
a wavelength separator configured to separate the light emitted from the nonlinear optical crystal into a fundamental wave and a harmonic component;
a second photodetector different from the photodetector which serves as a first photodetector; and
a second adjusting unit different from the adjusting unit which serves as a first adjusting unit,
wherein the first photodetector detects the fundamental wave from the wavelength separator,
wherein the second photodetector detects the harmonic component from the wavelength separator,
wherein the first adjusting unit adjusts power of the light incident on the nonlinear optical crystal based on a result of detection by the first photodetector, and
wherein the second adjusting unit adjusts a width of a pulse of the light incident on the nonlinear optical crystal based on a result of detection by the second photodetector.

8. The apparatus according to claim 1,
wherein the terahertz wave generating element includes a waveguide through which the light incident on the nonlinear optical crystal propagates,
wherein the waveguide includes
a core layer including the nonlinear optical crystal, and
a cladding layer having a smaller refractive index than the core layer in a terahertz band.

9. The apparatus according to claim 8, wherein the waveguide is ridge-shaped.

10. An information obtaining apparatus that irradiates a sample with a terahertz wave to measure the terahertz wave from the sample, the apparatus comprising:
a terahertz wave generating apparatus configured to generate the terahertz wave in response to the light, emitted from a light source, incident on the terahertz wave generating apparatus;
an irradiation unit configured to irradiate the sample with the terahertz wave generated from the terahertz wave generating apparatus; and
a detecting unit configured to detect the terahertz wave from the sample,
wherein the terahertz wave generating apparatus comprising:
a terahertz wave generating element including a nonlinear optical crystal configured to generate a terahertz wave in response to light incident on the nonlinear optical crystal;
a coupling member configured to extract the terahertz wave generated from the nonlinear optical crystal;
a photodetector configured to detect light emitted from the nonlinear optical crystal; and
an adjusting unit configured to adjust the light incident on the nonlinear optical crystal based on a result of detection by the photodetector.

11. The apparatus according to claim 10, further comprising:
a processing unit configured to obtain information about the sample based on a result of detection by the detecting unit.

12. A method of generating a terahertz wave, the method comprising:
allowing a nonlinear optical crystal to generate a terahertz wave in response to light incident on the nonlinear optical crystal;
extracting the terahertz wave generated from the nonlinear optical crystal;
detecting light emitted from the nonlinear optical crystal; and
adjusting the light incident on the nonlinear optical crystal based on a result of detection.

13. The method according to claim 12, wherein the adjusting adjusts power of the light incident on the nonlinear optical crystal.

14. The method according to claim 12,
wherein the light incident on the nonlinear optical crystal is pulsed light, and
wherein the adjusting adjusts a shape of a pulse of the light incident on the nonlinear optical crystal.

15. The method according to claim 13, wherein the adjusting reduces the power when the result of detection is greater than a predetermined value, and increases the power when the result of detection is less than the predetermined value.

16. The method according to claim 14, wherein the adjusting reduces a width of the pulse when the result of detection is greater than a predetermined value, and increases the width of the pulse when the result of detection is less than the predetermined value.

17. The method according to claim 15, wherein the predetermined value varies depending on a modulating signal.

18. The method according to claim 12,
wherein the terahertz wave generating element includes a waveguide through which the light incident on the nonlinear optical crystal propagates,
wherein the waveguide includes
a core layer including the nonlinear optical crystal, and
a cladding layer having a smaller refractive index than the core layer in a terahertz band.

19. The method according to claim 18, wherein the waveguide is ridge-shaped.

20. The apparatus according to claim 5, wherein the predetermined value varies depending on a modulating signal.
